(19) United States
(12) Patent Application Publication
(10) Pub. No.: US 2006/0291488 A1
(43) Pub. Date: Dec. 28, 2006

(54) System and method of interworking non-IMS and IMS networks to create new services utilizing both networks

(75) Inventors: Shamim A. Naqvi, Boston, MA (US); Prasad S. Dorbala, Lexington, MA (US); Ellis L. Wong, Lexington, MA (US); Mahesh N. Ganmukhi, Carlisle, MA (US)

Correspondence Address: WILMER CUTLER PICKERING HALE AND DORR LLP, 60 STATE STREET, BOSTON, MA, 02109, US

(73) Assignee: Aylus Networks, Inc.

(21) Appl. No.: 11/283,038

(22) Filed: Nov. 18, 2005

Related U.S. Application Data
(63) Continuation-in-part of application No. 11/166,406, filed on Jun. 24, 2005.
(63) Continuation-in-part of application No. 11/166,407, filed on Jun. 24, 2005.
(63) Continuation-in-part of application No. 11/166,456, filed on Jun. 24, 2005.
(63) Continuation-in-part of application No. 11/166,470, filed on Jun. 24, 2005.
(60) Provisional application No. 60/735,112, filed on Nov. 9, 2005.

(51) Int. Cl. H04L 12/56

(52) U.S. Cl. 370/401; 370/352

(57) ABSTRACT

Systems and methods of inter-working Non-IMS networks and IMS networks. An IMS network has at least one serving node and a non-IMS network has at least one MSC. The IMS and non-IMS networks inter-work so that network services may be provided to a user endpoint (UE) device, utilizing both the IMS network and the non-IMS network. An application server is provided in the IMS network. An identification of at least one UE is posted to the MSC. Corresponding triggers are posted for the at least one identified UE to the MSC. The triggers identify trigger events and identify the application server as the entity to inform in response to the trigger event. The triggers are associated with corresponding service to the UE via the non-IMS network.

### CROSS-REFERENCE TO RELATED APPLICATIONS

This application is a continuation-in-part of and claims priority under 35 U.S.C. §120 to the following applications, the contents of which are incorporated herein by reference in their entirety:
U.S. patent application Ser. No. 11/166406, filed on Jun. 24, 2005, entitled Mediation System and Method For Hybrid Network Including an IMS Network;
U.S. patent application Ser. No. 11/166407, filed on Jun. 24, 2005, entitled Method and System For Provisioning IMS Networks With Virtual Service Organizations Having Distinct Service Logic;
U.S. patent application Ser. No. 11/166456, filed on Jun. 24, 2005, entitled Method of Avoiding or Minimizing Cost of Stateful Connections Between Application Servers and S-CSCF Nodes in an IMS Network With Multiple Domains; and
U.S. patent application Ser. No. 11/166470, filed on Jun. 24, 2005, entitled System and Method to Provide Dynamic Call Models For Users in an IMS Network.

This application also claims the benefit under 35 U.S.C. §19(e) of U.S. Provisional Patent Application No. 60/735112, filed on Nov. 9, 2005, entitled System and Method to Allow Interruption of Unicast Data Service Utilizing a Class B Handset or a Dual Mode Handset (DMH) to Inform it of a Circuit-Based Incoming Call, so the Handset Can Accept the Call if the User Desires, the contents of which is herein incorporated by reference in its entirety.

This application is related to the following U.S. patent applications (Nos. TBA), filed on an even date herewith, entitled IMS Networks With AVS Sessions With Multiple Access Networks, and System and Method to Mediate Delivery of Legacy, Non-IMS Services into an IMS Network.

### BACKGROUND

1. Field of the Invention

The invention generally relates to IP Multimedia Subsystem (IMS) networks and, more specifically, to IMS user sessions that use multiple access networks.

2. Discussion of Related Art

Commonly deployed wireless communication networks, usually referred to as 2.5G networks, support both voice and data services. Typically, mobile handsets are connected to a Base Transceiver Station (BTS) using a Radio Access Network (RAN) that uses a modulation scheme such as CDMA (Code Division Multiple Access) or GSM (Global System for Mobile communications). The BTSs are connected via fixed links to one or more Base Station Controller (BSC) and the BSCs are aggregated into switches called Mobile Switching Centers (MSCs). The MSC is connected to the Public Land Mobile Network/Public Switched Telephone Network (PLMN/PSTN), typically through a gateway switch called the Gateway Mobile Switching Center (GMSC). Sometimes the term “core network” is used to collectively describe the MSC, GMSC and associated network elements. Voice traffic uses the so called circuit switched paradigm of communications in which circuits are assigned, i.e., dedicated, to a call for its entire duration; the voice traffic is carried using Time Division Multiplexing (TDM) switching technology. Signaling traffic uses Signaling System 7 (SS7) typically as out of band circuits.

With the advent of Internet Protocol (IP) networking, IP data service is offered to wireless clients by an overlay data network in which a packet control function (PCF) is introduced at the BSC level to connect BSCs to an IP-routed network. The PCF is responsible for packetization of RAN traffic. On the inbound side (core network to RAN) the PCF takes IP packets and reorganizes them for transmission as frames over the radio transport protocol. On the outbound side (RAN to core network) the PCF packetizes radio protocol frames to IP packets. Data connections are handled by this overlay network and the MSC is used primarily to handle circuit switched voice calls.

The development of Voice over IP (VoIP) technology has resulted in the MSC being re-designed to handle packet switched voice traffic along with existing circuit switched traffic. This new architecture is called a soft switch network. The legacy switch is disaggregated into a control and multiplicity of media gateway (MGW) components. The control component (sometimes called the soft switch) uses an open control protocol called the Media Gateway Control Protocol (MGCP) to manage the MGW. The MGW itself has the ability to accept both packet and circuit switched traffic and convert one to the other, under the control of the soft switch. It is thus possible in 2.5G networks to carry both circuit switched and packet switched traffic.

It is widely believed that wireless communications will soon be dominated by multimedia services. This has resulted in new RAN technologies and the resulting networks are called 3G networks. The transition of 2.5G to 3G networks emphasizes packet traffic and new architectures have been proposed to handle multimedia sessions, such as Quality of Service (QoS).

A defining characteristic of 2.5G/3G multimedia services is that since the handset can send or receive IP data packets at any time, the IP context of the handset is maintained as long as the handset is powered on and connected to the network. This is in contrast to traditional telephony where the state of a connection is maintained only while a telephone call is in progress.

In particular, in 3G networks the services are to be provided by so-called Application Servers. Consequently the connection between the service logic and the application server is a “stateful” connection that needs to be maintained for the duration of the service being used. Hence a very large number of stateful connections need to be maintained between the application server complex, hosted in the application domain, and the service logic complex hosted in the service logic domain, in a network servicing a large number of subscribers. Such stateful connections that cross administrative domains have high networking costs and are difficult to maintain operationally.

Typical of proposals for 3G network architecture is the IP Multimedia Subsystem (IMS) architecture, shown in FIG. 1. IMS is independent of the type of access network; that is, it applies both to wireless and landline networks. IMS uses Session Initiation Protocol (SIP) for control and signaling messages. SIP is an IP-based signaling protocol designed for multimedia communications. The IMS architecture introduces several control functions, i.e., functional entities, to manage the network. The legacy circuit switched traffic is handled by an Inter-working Function called the BGCF (Breakout gateway control function). The MGW is controlled by a new function called the Media Gateway Control Function (MGCF), and the media processing functions are performed by the Media Resource Function Processor (MRFP), which is controlled by the Media Resource Control Function (MRFC).

The basic call server called the Call State Control Function (CSCF) is logically partitioned into three functional entities, the Proxy, Interrogating and Serving CSCF.

The Proxy Call State Control Function (P-CSCF) is the first contact point for the handset, also referred to herein as the User Entity (UE,) within IMS and provides the following functions:
1. Forward SIP register request received from the UE
2. Forward SIP messages received from the UE to the SIP server
3. Forward the SIP request or response to the UE
4. Detect and handle an emergency session establishment request
5. Generate Call Detail Records (CDRs)
6. Maintain Security Association between itself and each UE
7. Perform SIP message compression/decompression
8. Authorize bearer resources and QoS management

The Interrogating CSCF (I-CSCF) is mainly the contact point within an operator's network for all IMS connections destined to a subscriber of that network operator, or a roaming subscriber currently located within that network operator's service area. It provides the following functions:
1. Assign a S-CSCF to a user performing SIP registration
2. Route a SIP request received from another network towards the S-CSCF
3. Obtain from Home Subscriber Server (HSS) the Address of the S-CSCF
4. Forward the SIP request or response to the S-CSCF as determined above
5. Generate CDRs

The Serving CSCF (S-CSCF) actually handles the session states in the network and provides the following functions:
1. Behave as SIP Registrar: accept registration requests and make its information available through the location server
2. Session control for the registered endpoints' sessions
3. Behave as a SIP Proxy Server: accept requests and service them internally or forward them on
4. Behave as a SIP User Agent: terminate and independently generate SIP transactions
5. Interact with application servers for the support of Services via the IMS Service Control (ISC) interface
6. Provide endpoints with service event related information
7. Forward SIP message to the correct CSCF
8. Forward the SIP request or response to a BGCF for call routing to the PSTN or CS Domain
9. Generate Call Detail Records.

The P-CSCF is the first point of contact for a UE (handset) in an IMS network. The I-CSCF then helps in establishing which S-CSCF “owns” the UE.

FIG. 2 is a signaling diagram 200, showing the call flow for a UE when it first establishes contact with an IMS network. The UE sends a “register” request to the proxy. Assuming the proxy determines that the UE is registering from a visiting domain, it queries the DNS to find the I-CSCF in the UE's home domain. The proxy then sends the registration information to the I-CSCF. The HSS checks if the user is already registered and sends the address of the S-CSCF in response. An authentication process now ensues in which the UE is challenged to provide valid authentication vectors. Once the authentication procedure is completed, the S-CSCF informs the HSS that the UE is registered.

The HSS provides initial filter codes (IFCs) to the S-CSCF. The IFC, in effect, maps the service codes with various application servers (ASs). Thus, if the UE later issues a service request or if the service is otherwise triggered the mapped AS will be invoked. The IFC is effectively the “call model” for the UE. These call models are static objects downloaded during registration from the HSS. Every UE in the domain of the S-CSCF will, if they have the services enabled at all, have the same application servers (ASs) mapped to the same services. For example, push-to-talk service for each and every UE having such service will point to the same AS or point to an AS with identical service logic to provide the identical push-to-talk functionality.

Registered UEs may use services by initiating a new session establishment procedure depicted in FIG. 3. The figure shows a session establishment request originating with a S-CSCF (called O-SCSCF) or I-CSCF (called O-ICSCF). This request is routed to the “terminating” S-CSCF (T-SCSCF), which consults the callee's service profile. Based on the service profile of the originating registered user, the T-SCSCF sends an IMS service control request (ISC) to the corresponding application server (T-AS) that can handle this service request. The T-AS provides the service to the callee and terminates the session and the S-CSCF terminates the application activation process.

As an illustrative example, consider the case of voice mail in which callers to a certain user may leave a voice message if the called user does not respond to the call. This voice mail service is provided by an application server (AS) dedicated to this service and having service logic to provide such functionality. The S-CSCF transfers control to the voice mail application server when a certain service point trigger (SPT) occurs, i.e., an event occurs that causes a trigger within the SPT to “fire.” The IFCs that provide trigger points to the service logic of the S-CSCF are downloaded into the S-CSCF during user registration at session initiation time and remain fixed for the duration of the session. The service profile described above that is consulted by the T-SCSCF is a static object in the sense that the information contained in it is defined once at the time of service inception.

The coverage area of a service provider is typically partitioned into geographical regions called cells. Each cell is served by a BTS, i.e., the BTS radiates energy within a cell. Allocating frequencies to cells in a judicious manner allows re-use of frequencies and, hence, to more efficient use of the operator's spectrum allocation. As a mobile handset roams across cell boundaries, its reception of the signal being radiated by the BTS varies. A crucial component of wireless communication networks is the ability to handoff a moving handset from one BTS to a neighboring BTS. Various handoff algorithms are known in the literature. Broadly speaking, all handoff technologies fall into one of two types: hard handoff, and soft handoff.

In hard handoffs the connection between the current BTS and the handset is severed and a new connection is established between a new BTS and the handset while a telephone call is ongoing. The decision to sever the old connection and start a new connection is based on a pre-determined threshold value of the received signal. In soft handoff technologies the signal strength from two (or more) BTS are compared and the one that has the higher value is selected. The main advantage that handoffs provide is that ongoing calls remain connected as the handset roams in the coverage area. Since the region in which a BTS radiates is limited, a handset that roams out of the range of a BTS will lose connection with the BTS and hence any ongoing call will be dropped. Handoffs ensure that the handset remains connected to some BTS and any ongoing calls do not get dropped.

As the bandwidth provided by wireless networks increases, it is now possible to send and receive multimedia information to handsets. Thus, handsets are no longer used only to make and receive telephone calls. Rather handsets are envisioned to send and receive multimedia information such as video clips, audio files, etc. Handsets have become general purpose computing and communication devices. Wireless networks are now expected to provide broadcast content, video telephony, multimedia conferencing, video streaming services, file upload and download services, and interactive multimedia services.

However, the availability of network coverage supporting multimedia services is highly uneven. In some areas several networks may be available simultaneously that could be used by a handset, whereas in other regions there may be insufficient coverage to support a given network service. For example, at a given location one may have several short-range WiFi or WiMax networks, or 1xRTT EVDO, that could provide multimedia services to a handset (assuming that the handset is capable of supporting multiple modulation schemes).

In such a multi-network environment it is imperative that the correct network be chosen to provide a given service to a handset. Since current handoff technology only examines the signal strength of coverage within a single network, such a discriminating choice of network can not be made by current handoff technology.

The wireless world is increasingly becoming a world of multiple networks. Some are short range and others support longer ranges of coverage. The information carrying capacity of these networks varies widely from network to network. A given network does not provide uniform coverage over its entire footprint. The trend to multimedia information in wireless networks is expected to grow.

### SUMMARY

The invention provides systems and methods of inter-working Non-IMS networks and IMS networks.

Under one aspect of the invention, an IMS network has at least one serving node and a non-IMS network has at least one MSC. The IMS and non-IMS networks inter-work so that network services may be provided to a user endpoint (UE) device, utilizing both the IMS network and the non-IMS network. An application server is provided in the IMS network. An identification of at least one UE is posted to the MSC. Corresponding triggers are posted for the at least one identified UE to the MSC. The triggers identify trigger events and identify the application server as the entity to inform in response to the trigger event. The triggers are associated with corresponding service to the UE via the non-IMS network. Subsequent to the posting actions, a service is invoked to utilize the IMS network to provide service to the UE. Subsequent to the service being invoked to utilize the IMS network, the non-IMS network attempts to contact the UE and in the process activates one of the triggers and informs the application server. The application server responds to the triggers to contact the UE via the IMS network, in response to being informed of the trigger.

Under another aspect of the invention, the triggers are posted and armed when the UE registers in the network as part of authenticating the UE specification of services in the UE profile.

### BRIEF DESCRIPTION OF THE FIGURES

In the Drawings,

FIG. 1 depicts a prior art IMS network;

FIGS. 2 and 3 are signal diagrams for a prior art IMS network;

FIG. 4 depicts a certain embodiment of the invention;

FIG. 5 depicts logic for providing per user (or group) call models according to a certain embodiment of the invention;

FIG. 6 depicts internal architecture of a certain embodiment of the invention;

FIG. 7 depicts logic for providing dynamic call models according to a certain embodiment of the invention;

FIG. 8 is a simplified network diagram to illustrate the interaction between a UE, a CSCF and an application server according to certain embodiments of the invention;

FIG. 9 is a simplified network diagram to illustrate the interaction between a UE, a CSCF and a dynamic network topology database (aka ME database) and server and policy database according to certain embodiments of the invention;

FIG. 10 depicts certain embodiments of the invention utilizing multiple access networks and having an AVS structure;

FIG. 11 depicts out-of-band mediation by a control point to use a potentially non-IMS service in an IMS context;

FIG. 12 depicts out-of-band mediation by a control point and a control point proxy to use a potentially non-IMS service in an IMS context;

FIG. 13 depicts a certain embodiment of the invention in which a broadcast network has been mediated to provide content to be rendered on a UE; and

FIG. 14 depicts an embodiment of the invention allowing IMS and non-IMS networks to inter-work.

### DETAILED DESCRIPTION

Preferred embodiments of the invention permit IMS user sessions to utilize multiple access networks. Among other things, preferred embodiments allow a superior, or correct, access network to be chosen for a given multimedia service. The access network delivers data or acts as a bearer circuit for the service. For example, a service may begin using Edge/GPRS within a 2G/3G network and the access network may be handed-off to a WiFi access network, such as UMA-enabled WLAN. Moreover, this choice of access network may be made dynamically, especially helpful since the users (handsets) are mobile. And the choice may be policy-based (i.e., not just based on signal strength) and based on the immediate context of the user's environment.

There are three basic problems being addressed by preferred embodiments of the present invention.
1. IMS states that it is independent of particular access networks, i.e., it is a core network technology that can run on any access network (landline or wireless). Examples of landline networks are DSL, cable (packet cable 2.0), broadband, etc., any one of which can terminate in a WLAN (or similar) environment. What this statement does not cover is the fact that as a user (or more correctly UE) roams from one access network to another, the new access network represents a completely different session to the IMS system. Preferred embodiments of the invention address this problem by providing a way to logically connect the old and the new sessions together. This allows the embodiments to preserve voice and data continuity of service. Technologies such as Mobile IP allow the IP address to remain consistent across different access networks but it does not guarantee application/service continuity. Once the embodiments have established a logical connection between the old and new sessions then they must decide whether the old session is to be “cleared” or kept around for some reason.
2. Many carriers are implementing new services (applications) that do not use IMS today. Preferred embodiments of the invention will support “legacy” services as if they were IMS services to allow re-used of infrastructure. Examples of legacy services that do not use IMS infrastructure today are Mobile TV (offered by Sprint, Cingular), MMS (multimedia messaging service) for sending digital photographs, Email, etc.
3. Moreover, preferred embodiments of the invention will support inter-working of IMS and legacy telecomm networks. For example, under today's technology and conventional proposals, a user who is watching MobileTV on a handset can not receive a telephone call. However, preferred embodiments of the invention will provide mechanisms so the user may receive the telephone call; indeed the full range of supplementary telephone services will be made available.

As will be explained in more detail below, the first problem is addressed through a new modeling entity, referred to here as an audio-video session (AVS), and corresponding control logic that uses the model. The second problem is addressed through out-of-band signaling using a control point (CP). The third problem is addressed by a new logic entity called a service continuity function (SCF).

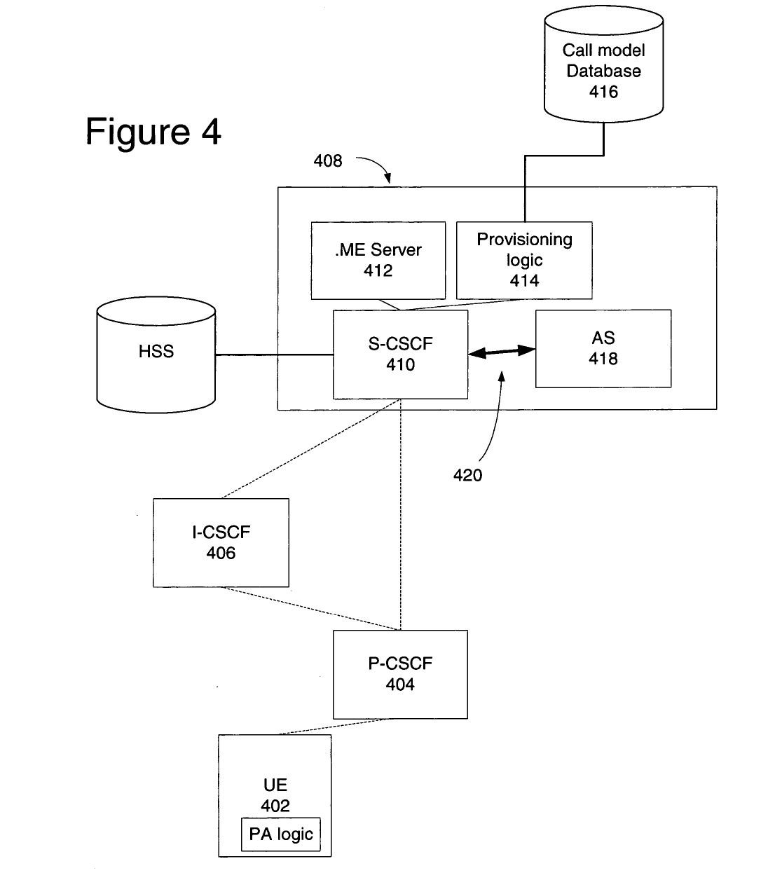

FIG. 4 depicts relevant portions of an IMS network according to preferred embodiments of the invention. The relevant portions include a UE 402, a P-CSCF 404, an I-CSCF 406, a serving node 408, an HSS, and a call model database 416.

The UE, P-CSCF 404, I-CSCF 406, and HSS are essentially conventional, though the content of the HSS is not, as described below. However, in certain embodiments, discussed below, the UE may have unconventional agent logic (e.g., personal agent, or PA, logic). All of these entities communicate using known and defined protocols.

The serving node 408, in preferred embodiments, includes S-CSCF logic 410 that is largely conventional though it includes certain modifications, discussed below. The serving node 408 also includes ME server logic 412 (more below) to store users' dynamic network topologies and other information, and provisioning logic 414 more below. (Alternatively, the ME server logic and the provisioning logic may each be a separate physical entity like an AS.) The ME server and provisioning logic essentially are co-located special purpose servers within node 408. The serving node 408, and particularly provisioning logic 414, communicates with a call model database 416. This database 416 (not the HSS as is the conventional case) is used to provide the call model information for a given user (more below).

Though not shown in FIG. 4, the serving node 408 communicates with application servers (ASs) that include service logic for various services, e.g., voice mail, push-to-talk, etc. The UEs use predefined codes within service requests to identify the service of interest and/or these services can be triggered in known specified ways via SPTs (as is the conventional case).

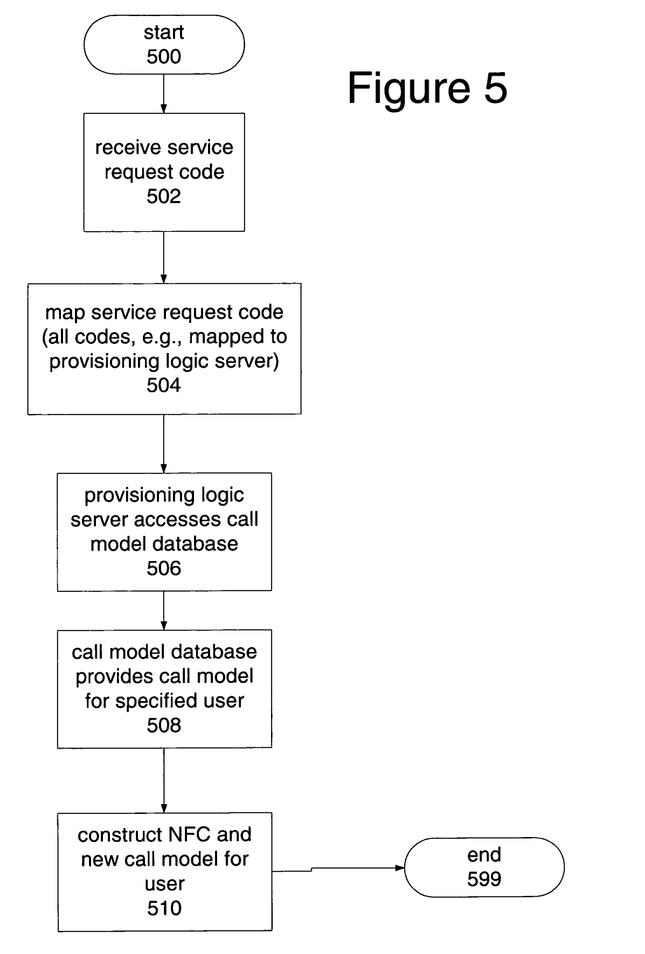

FIG. 5 depicts the logic flow for provisioning a S-CSCF with distinct call models for each user. Under preferred embodiments, the HSS provides initial filter codes (IFC) during UE registration (as is the conventional case). However, under certain embodiments of the invention, this IFC is programmed in an unusual way. All the service point triggers (SPTs) for each service are mapped to provisioning logic 414 (i.e., not to ASs corresponding to the actual service codes as is the conventional case).

The logic flow starts in 500 and proceeds to 502 in which the first service request is received after registration. Because of the default IFC, this service request will not trigger an AS corresponding to that service, and instead will trigger activation 504 of the provisioning logic 414. The provisioning logic 414 will then access 506 the call model database 416. One of the input parameters will identify the user. The call model database 416 will retrieve a call model for that particular user. This call model will include the AS identifiers for the various services for that user. The database 416 will provide 508 the call model information to the provisioning logic 414 which in turn will provide it to the S-CSCF logic 410 within serving node 408. The S-CSCF 410 will construct a new set of filter codes, i.e., NFC, and thus a new call model, for that user (and will trigger the service requested initially using the NFC). The NFC will have SPTs identifying the corresponding ASs. This approach allows for dynamic construction of the NFCs (e.g., post registration) and allows the call model (e.g., NFC with associated SPTs) to be constructed uniquely for each user.

The above logic allows each user to have a call model and NFC that can differ from all other call models served by that S-CSCF. This functionality may be used in many ways. Per-user differentiated call models is useful though not strictly necessary to practice preferred embodiments of the invention. Consider a mobile subscriber in a real time video session with a network server using a low bandwidth access network. The media may be rendered on the handset by a media rendering program. Now assume the subscriber gets access to a higher bandwidth access network. This implies that now the handset may use a different media rendering program, e.g., switch from Windows Media Player to Quicktime Player for a better user experience. This choice could be dictated by the content provider or stated in the subscriber's profile. Notice that this may or may not imply a change of the user device, and instead the only change may be with respect to a media rendering decision.

This form of per user call model customization, in which different users may invoke different service logic functionality for the same given service request, is not provided in a conventional IMS network. In conventional IMS arrangements, the HSS provides static call models at UE registration. Each user gets the same ASs within their IFC and thus the same service experience (for services they are authorized to use). Moreover, the above approach allows for full portability of call models. No matter where a UE exists in the IMS network, that UE's call model may be constructed and used for that UE's service experience.

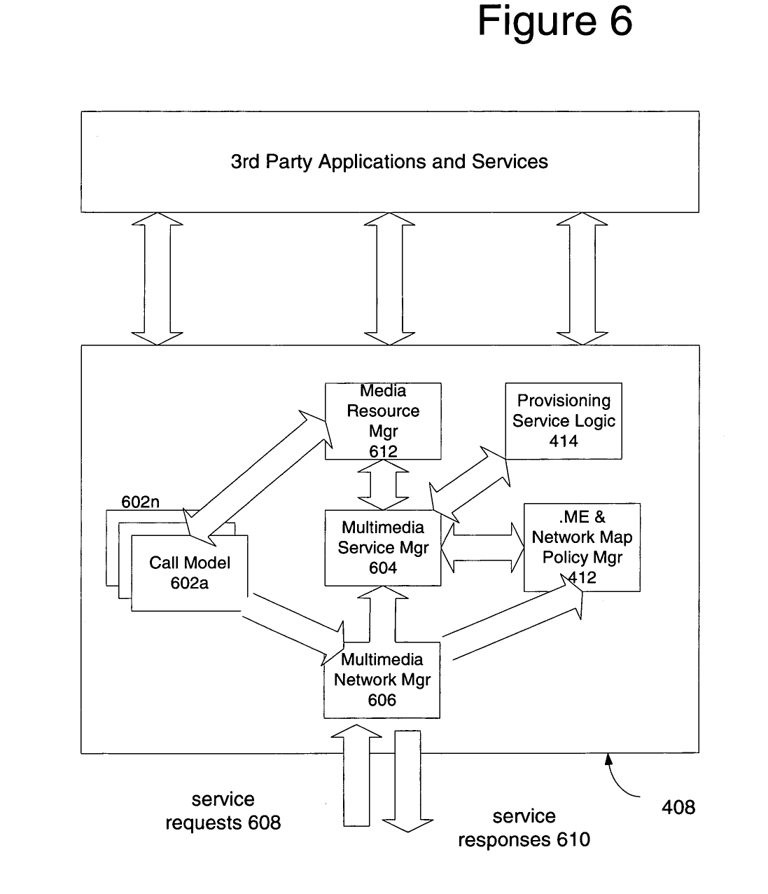

FIG. 6 depicts serving node 408 once multiple UEs have registered and been provisioned with their corresponding call models 602a . . . n. Note, the different call models can point to different ASs for a given service, and they are not merely multiple instances of the same IFC/call model. Multimedia network manager 606 receives service requests 608 from the IMS network and provides service responses 610 to the IMS network. It also routes received requests to the appropriate internal entities as shown. ME server logic and Network Map policy manager 412 is responsible for receiving information (more below) indicating that the user's UE environment has changed with new capabilities or devices, and for building information structures and models to reflect these capabilities. In certain embodiments it also includes logic to implement specified policies on whether and how to utilize such capabilities. Provisioning Service logic 414 is responsible for interacting with external or internal databases (e.g., database 416 of FIG. 4). Media resource manager 612 is responsible for managing other resources (e.g., transcoders) that may be involved with a given service. Multimedia service manager 604 is responsible for receiving requests from network manager 606 and for interacting with the other components to construct and build the per-user call model 602. In simple cases this may involve creating call models with the help of the provisioning logic 414 and call model database 416. In other cases the call model construction will be dynamic (more below) using new devices and capabilities (as well as associated policies), and in these instances the manager 604 will involve ME logic 412 and media resource manager 612.

The context of an end user may change. For example, as a user roams his or her context may change. Alternatively, even in non-roaming situations, the user context may change as new devices and capabilities emerge or become activated.

At any given moment in time the user may be in close proximity to any number of devices that are capable of acting as a UE for a certain service (application). For example, the user may be near a TV that could be used to display multimedia content. By way of another example, the user may be in close proximity to a personal computer that could be used to receive multimedia information from a network connection, provided network connectivity and authorization to use such a device in this manner could be obtained.

According to certain embodiments, a roaming user may discover (directly or indirectly) several kinds of information and invoke several kinds of corresponding relevant policies to consider when and how to use such capabilities and devices:
1. New endpoint devices (UEs or UE devices) that could be used to receive multimedia information
2. New network connections that terminate and emanate from the UE devices
3. New device capabilities
4. Policies that govern use of newly discovered devices and new network connections
5. Policies that are implemented by the service provider that control what devices could be used for which type of services under what sort of conditions

An increasing number of mobile handsets support short-range wireless technologies such as Bluetooth and Wi-Fi. According to certain embodiments, a “dynamic profile” is constructed, in part, by logic that executes in the handset. This logic may be executed continuously, periodically at some network determined time interval, or on demand when the user requests a particular service. When executed, the logic senses (or otherwise discovers) the presence of associated devices in the immediate vicinity of the handset using a short-range wireless technology such as Wi-Fi. Associated devices may announce their presence by a variety of means such as but not limited to:
1. Universal Plug and Play Devices (UPnP)
2. Jini discoverable devices
3. RFID devices
4. Bluetooth enabled devices

Any method of broadcasting the capability of devices can be used. The sensing logic in the handset receives such broadcast information and assembles it to construct a dynamic profile of the user's immediate context. Since this context changes as the user roams, the dynamic profile changes to reflect the current vicinity of the handset. The dynamic profile is communicated to the serving node 408. For example, this information may be communicated as parameters (e.g., by overloading information elements [IEs] of SDP protocol messages) in conjunction with a special service request dedicated to communicating potential UE devices.

A personal agent (PA) (not shown) executes in the UE (handset) and includes the sensing logic to discover such other potential UEs or associated devices (more below). The dynamic profile of the user's immediate environment is communicated to the ME logic 412. This is done by having the ME server invoked in response to the special service request from the UE for communicating such discovered devices and capabilities. The ME service will construct topologies and maps to identify the potential UEs, other networks, etc., to reflect the new devices and capabilities discovered or sensed in the UE's vicinity that could potentially be used by a given user.

In certain embodiments, the static user profile downloaded by the HSS into the S-CSCF at registration time is provisioned by the network operator to contain the address of the ME server. Thus, every communication of the dynamic profile originating from the UE and received by the S-CSCF causes a SPT trigger to fire, and control is transferred to the corresponding ME server. In this fashion the serving node 408 and more particularly the ME server 412 becomes aware of the immediate context of the UE (handset).

Once the ME server has the information in the dynamic profile, it consults a database of policies described by the service operator. These policy descriptions may be co-located with the ME logic and even the S-CSCF logic (see, e.g., FIG. 6). These policies prescribe certain actions that depend on the data contained in the dynamic profile. For example, a policy can require that if the UE sensing logic discovers a Wi-Fi connection in its immediate vicinity, then this discovered network should be used for originating session requests. Specific logic associated with this policy is then executed to send directions to the PA to enforce this directive at the UE level.

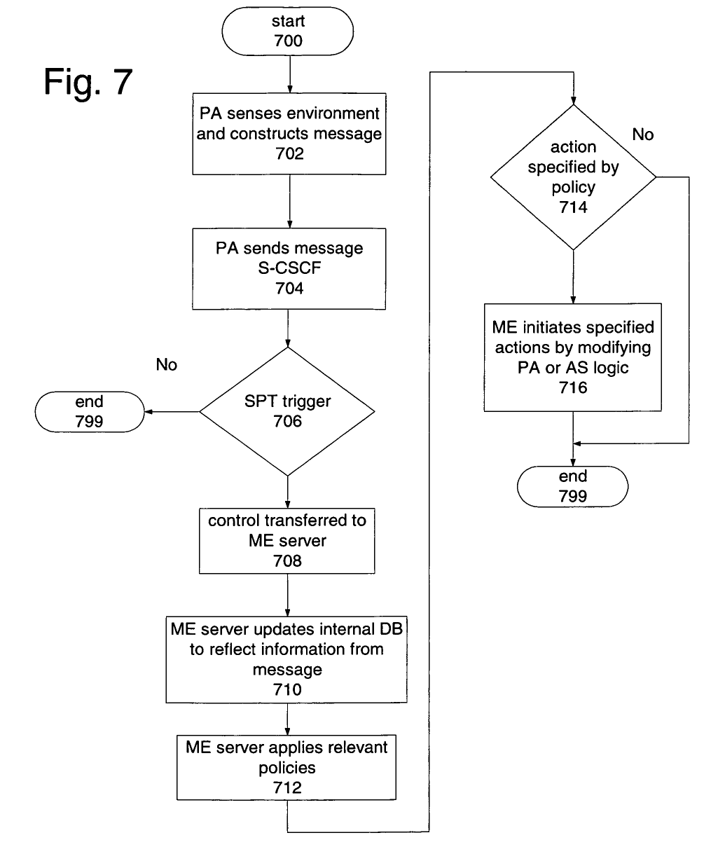

FIG. 7 is a flow diagram illustrating the customization of service logic. The logic starts in step 700 and proceeds to step 702 in which the PA logic on the UE discovers or senses its immediate environment or context and constructs a message specifying this dynamic context. This message may include information about, new devices that could be used to receive multimedia information, new network connections that terminate and emanate from such devices, and new device capabilities. In step 704 the PA on the UE sends the message to S-CSCF. In step 706 the message either causes an SPT trigger or it does not, depending on how the IFC or NFC is constructed. For the relevant embodiment, it causes such a triggering event and the logic proceeds to step 708. In step 708, control is transferred to the ME server. In step 710 the ME server updates its internal database to reflect the information communicated in the message from the PA in the UE. The ME server, in step 712, then applies any relevant policies that will determine, for example, whether and how to utilize newly discovered devices and capabilities. Then, in step 714, the logic determines whether any action is specified by the policy. If so, in step 716 the specified action is initiated. This can be done by customizing the PA logic on the UE. It may also be done by customizing the AS logic. For example, in a typical embodiment, S-CSCF logic will be modified to initiate or trigger the specified actions after the ME logic has updated its models accordingly and perhaps after a new dynamic call model is constructed for that particular user to reflect new devices and capabilities.

In an alternative embodiment the S-CSCF logic 410 is not hosted within a serving node 408 as shown in FIG. 4; that is, the S-CSCF 410 is not constrained to be hosted by the MVNO domain. In this embodiment the S-CSCF remains hosted in the IMS serving domain of the network operator and is a separate entity, as in a conventional IMS network, and the ME server and provisioning logic are configured as ASs, though, as explained above, they do not provide conventional IMS services and instead are used in the construction of dynamic call models.

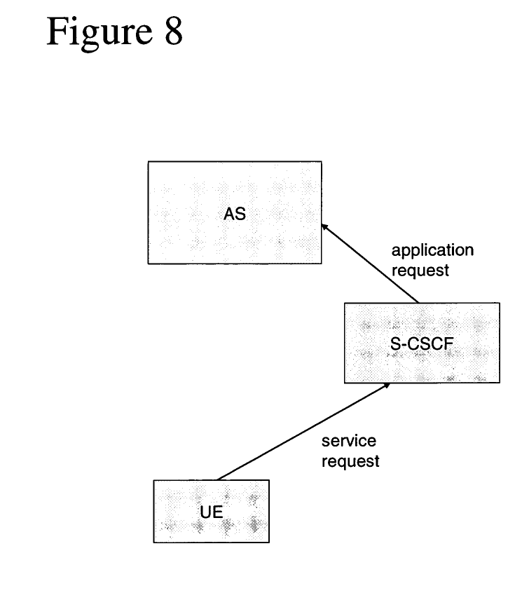

The interactions between the CSCF and an AS can be summarized as shown in FIG. 8. As outlined above, in IMS networks, all services are provided by application servers (ASs). In FIG. 8, the network is simplified (for descriptive purposes) to show only one such AS 802 but in practice there will exist multiple such servers. In short, service requests are sent (directly or indirectly) from a UE 402 (see also FIG. 4) to a S-CSCF 410 (see also FIG. 4). The S-CSCF uses its internal call model (see, e.g., 602 of FIG. 6) to invoke a corresponding application server.

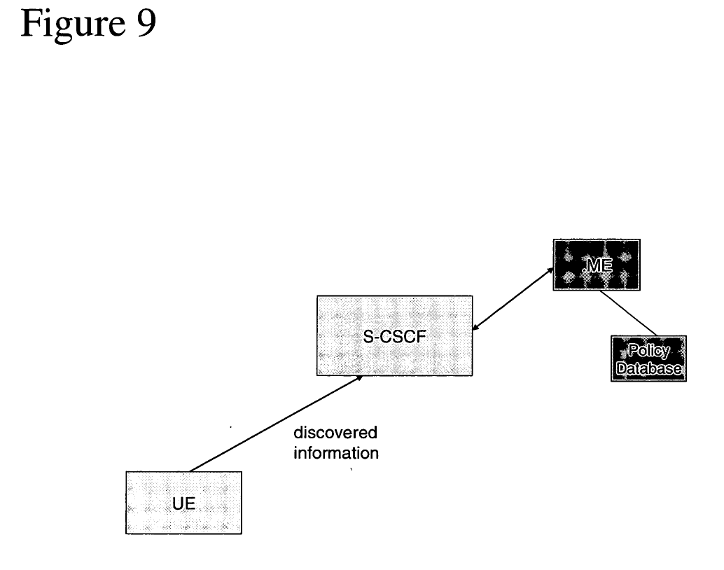

In preferred embodiments, the call model (i.e., state machine) executing in the S-CSCF 410 for this UE is modified to take into consideration the newly discovered devices and network connections as described above. This newly discovered information is stored in the ME server 412. The discovery is done by sensing logic resident in the LE and may be communicated to the ME server periodically or when discovered or at pre-designated intervals (as discussed above this communication may be done by, for example, by overloading the information elements of the SDP). The interaction between the ME server 412 and the CSCF 410 is shown in FIG. 9 below. In short, as described above, the CSCF 410 is invoked with messages (or overloaded messages) which include information about discovered devices, network connections, new capabilities, etc., as discussed above. The CSCF 410 then invokes the ME server 412 which in turn consults the policy database 902.

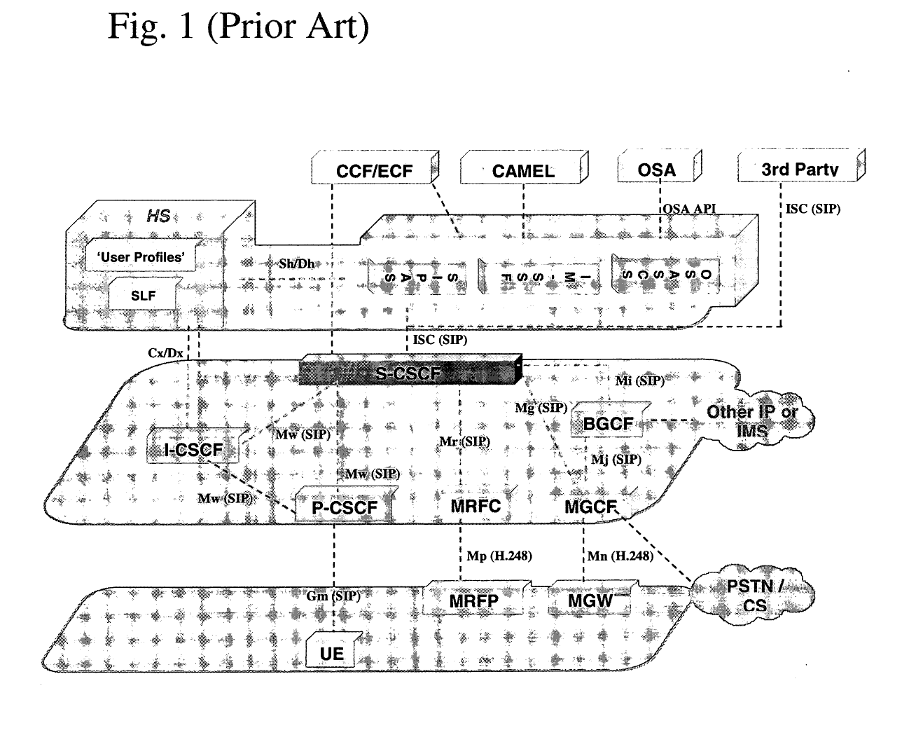

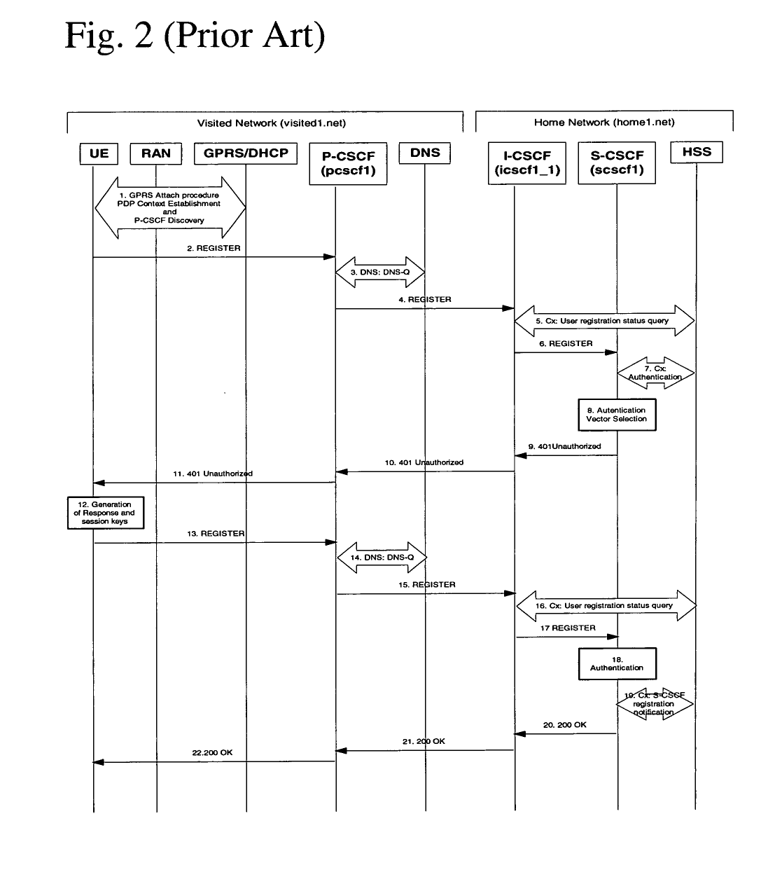

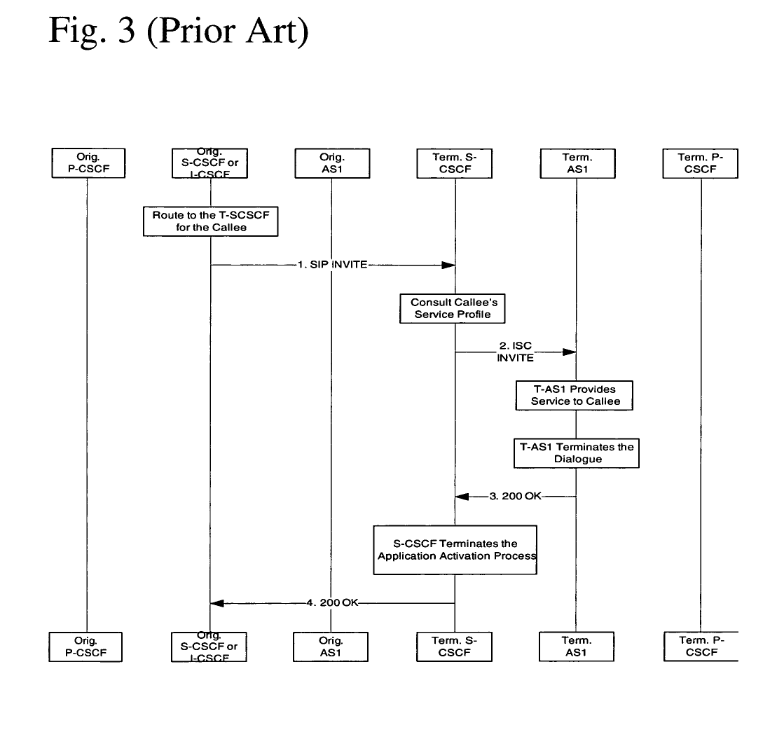

In order to explain in more detail the working of preferred embodiments of the invention consider, by way of example, a subscriber initiating an IMS request to a serving node 408 (e.g., subscriber wishes to view multimedia content available from an Internet server on the handset). The subscriber's request emanates from the UE to the P-CSCF and onwards to the S-CSCF as explained above in connection with FIG. 1, for example. From the S-CSCF it is routed to the ME (acting as an Application server) so as to do any per subscriber customization as explained in connection with FIG. 4, for example. This request then causes a connection to be made to the serving node 408 (explained in more detail later) and an IMS session is established between the serving node 408 and the UE using the access network to which the P-CSCF is attached. This IMS session is uniquely identified by an IMS Charging ID (ICID) assigned by the P-CSCF.

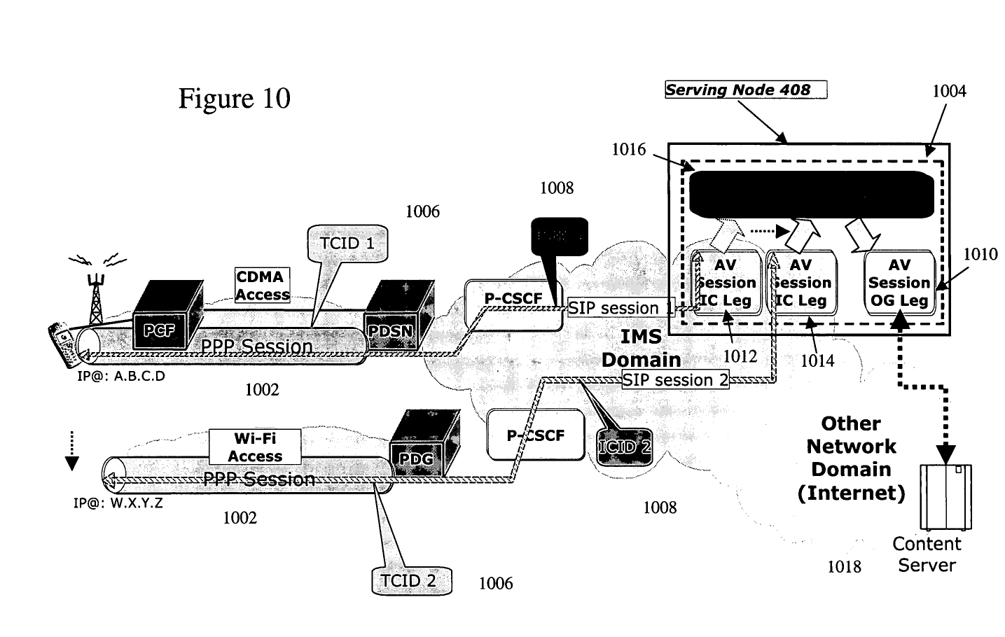

As shown in FIG. 10, the PPP (Point to Point Protocol) session 1002 has its own unique identifier called the Transport Charging ID (TCID) 1006 assigned by the device (Packet data Gateway or Packet Control Function in the BSC) from which the PPP session emanates. The TCID and ICID 1008 together uniquely identify the multimedia session in which the SIP/IMS signaling is embedded within the IP/PPP connection.

In preferred embodiments of the present invention the ME function 412 creates or modifies a computational entity called an AVS (Audio Video Session) 1004 to model and control (in part) the actual access network connections for a given UE. The call model 602a, discussed previously, gets built first. Its construction is based on the resources and policies. The AVS, on the other hand, is representative of what is actually going on, or intended to take place, or that takes place (i.e., dynamically modifying to context). That is, the AVS represents the actual connections registered or to be registered in response to a given service request. If each access network connection is considered to be a “session”, then the AVS is a form of meta-session or a super-session, a session incorporating these access network sessions. Each AVS is uniquely identified by a AVID (Audio Video session ID) that is a function of the underlying TCID and the ICID.

The simplest way to think of an AVS is that it is a representation of every access network that the UE encounters while roaming. For each new access network this representation creates a new “leg” (called Incoming Call Leg—ICL 1012, 1014). Each ICL has associated with it a TCID and an ICID (generated by other network elements) that together uniquely identify the session corresponding to that access network. Since the AVS 1004 has access to registration information of the UE, it knows that various ICLs (and hence various TCID+ICID combinations) really belong to the same UE, and hence, for each UE, the AVS representation captures all the access networks that the handset encounters. And since some access networks may support circuit-switched (CS) transport mode whereas others may support packet-switched (PS) transport modes, ICLs may be CS or PS supporting ICLs.

Network policies (see, e.g., FIG. 9) will generally apply to the co-existence of ICLs within a single AVS (recall that an AVS is per UE). For example, current telecomm networks do not support the idea of a UE being associated with more than one circuit switched network. This will translate into a constraint on the AVS of a UE “only one ICL may exist for CS sessions.” Another example of a constraint is provided by current so-called Class B handsets in which both a CS and PS protocol stack are available but only one such stack can execute at any time. Yet another example is provided by Class B+wifi handsets in which we could have a CS session and a wifi session simultaneously, or a wifi and a PS session simultaneously. If we have a Class A handset that supports CS, PS and wifi—all contemporaneously—we could have all three sessions active together. All such constraints, emanating from the network or the handset translate into how many and what kind of ICLs can be supported by an AVS. The policies can be contained in the policy database, and analogously to the situation with the construction of call models, the policies may be accessed when modifying AVSs.

Consider, by way of example, a class B UE engaged in a PS session, say watching Mobile TV. The UE roams into a WiFi zone and assume a handoff happens, after which the MobileTV feed uses the wifi network. The previous PS session is idle and could be cleared. However, keeping it around serves a useful purpose. For example, suppose a voice call arrives for this UE. Since the CS stack is not executing in the UE, the call will normally be routed to voice mail without the user being informed of the call. But suppose a serving node 408 is informed of the arrival of this call (how will be explained below), which then uses the PS session to present a dialog box giving the user a choice to take the voice call. This example shows the usefulness of having more than one session (more than one ICL) active. Policies governing a given service will dictate whether or not to keep a leg active or to clear such. Moreover, in certain situations, a leg may be unavoidably dropped, for example via lack of sufficient use, or signal issues.

As stated above, the serving node 408 includes one AVS per UE, in preferred embodiments. As shown in FIG. 10, an AVS 1004 includes perhaps multiple ICLs 1012, 1014 and an OCL or OGL 1010 (outgoing call leg). The AVS also includes a control point 1016. As will be explained shortly, the control point (CP) may be used to provide mediation between some form of service or server and the UE. Not shown in FIG. 10 is that each leg may have effectuation routines to perform or effectuate routine functions on a given access network, such as responding to “are you alive” messages etc. When the serving node 408 (e.g., via the ME logic) manipulates the AVS it corresponds to actions in the “real world.” For example, adding an ICL means getting registered on that access network.

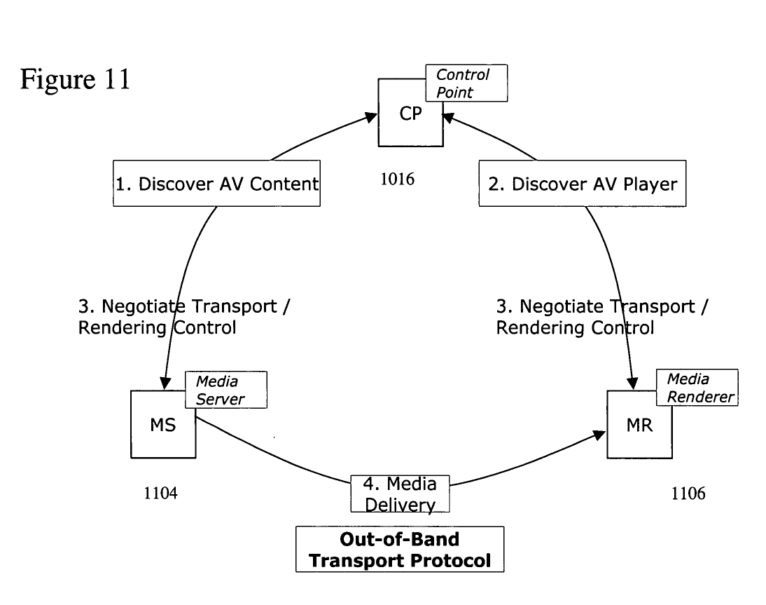

FIG. 11 is useful for illustrating how certain components, particularly the CP 1016 interact with other entities and for how preferred embodiments of the invention address the second problem, i.e., incorporating non-IMS (legacy) services into a network, or “marrying” multiple networks. As will be explained below, the CP 1016 within AVS 1004, under certain embodiments will perform out of band mediation so that a media server (MS) 1104 somewhere in the network can deliver content to a media renderer (MR) program 1106 on the UE, which will receive and present such content.

The CP 1016 is connected to the MS 1104 which in turn establishes a connection to the serving node 408 (using network server specific protocols). The connection between the CP and the MS is internal to the ME 412. The connection between the MS and the serving node 408 is an Outgoing Leg 1010 of the AVS. That is, the AVS 1004 models this connection as an outgoing leg component 1010. The CP 1016 is also connected to the MR 1106. In preferred embodiments of the present invention the MR resides in the UE. The connection between the CP and the MR is an Incoming Leg, e.g., 1012. That is, the AVS 1004 models this connection as an incoming leg component 1012 or 1014. Thus it can be ascertained that for multiple MRs there will exist multiple Incoming Legs for a single AVS, as shown in FIG. 10.

Continuing with the example above, the CP negotiates multimedia content delivery with the MS. In short, the CP instructs the MS to deliver content to an address corresponding to the MR on the UE. The instructions provided during such mediation will conform with the environment, context, and capabilities of the UE. The CP 1016 also negotiates media rendering with the MR itself in each Incoming Leg of the AVS. That is, the CP effectively instructs the MR to start expecting content from the MS, and to present such. Again, the instructions provided during such mediation will conform with the environment, context, and capabilities of the UE.

In preferred embodiments of the present invention, when an access network connection is discovered by the sensing logic in the UE and said information is communicated to the ME server 412 and, moreover, if the policy database 902 (see FIG. 9) does not forbid or exclude the newly discovered network connection, the newly discovered access network connection is modeled and included into the current AVS as an Incoming Leg. Each access network available to a UE corresponds to an Incoming Leg of an AVS and the connection between the CP and MS corresponds to the Outgoing Leg of the AVS.

Thus, if the UE has sensed three different access networks and all three are allowable by policy, then there will exist three distinct access network connections between the UE and the S-CSCF, one for each allowed network connection. In such a situation, there will be signaling and bearer channels in each access network that can be utilized. In preferred embodiments of the present invention it is a matter of policy that decides which signaling channel within an access network is to be used and which channels within an access network is to be used for bearer traffic. In the case when coverage of an access network is lost (due to roaming of the UE), the corresponding access network connection and the associated AVS Incoming Leg is “cleared” under S-CSCF serving logic control by the P-CSCF.

As mentioned above, many new kinds of access networks are being deployed such as WiFi and WiMax, etc. The proposed IMS specifications allow the UE to connect to an access network. Preferred embodiments of the present invention allow the UE to remain in simultaneous connection (or potential use) with multiple access networks and the choice of which access network to deliver a particular service to the UE is to be made by policies resident in the ME function in the serving node of the network. That is, the AVS facilitates control of multiple access networks (both signaling and bearer) and allows choices to be made (by the system and perhaps the user) as to which network to use in a given context and at a given instant in time.

In conjunction with deployments of various kinds of access networks, handset manufacturers are also producing handsets that support multiple radio access technologies. Examples of such handsets today are those that support WiFi and GSM/CDMA cellular networks. In such handsets known as Class A handsets both the circuit switched session of the GSM/CDMA network and the packet switched session of WiFi can co-exist and be active simultaneously. Moreover various proposals abound in the literature for doing handoffs of voice calls between cellular (GSM/CDMA) and WiFi networks.

Using the system and method of preferred embodiments a Class A handset can have multiple packet sessions and a circuit switched session simultaneously active in the handset. In our terminology explained above the corresponding AVS may have multiple Incoming Legs corresponding to one circuit switched and multiple packet switched sessions. Another type of handset called a Class B handset only supports either a circuit switched session or a packet session at any given time, not both simultaneously. As is envisaged by various proposals if the handset now roams into a WiFi area from a cellular area, the circuit switched session will be replaced by a new packet switched session supported by the new WiFi network in a Class B handset; in a Class A handset the circuit switched session can be allowed to remain as is, i.e., it need not be cleared. In our terminology this is tantamount to replacing one Incoming Leg of the AVS (corresponding to the circuit switched cellular connection) and adding another Incoming Leg (corresponding to the WiFi connection) to the underlying AVS for Class B handsets. In the case of Class A handsets in which the circuit switched session is not cleared, the situation is tantamount o simply adding another Incoming Leg to the AVS session.

It should be clear from the above explanation that the preferred embodiments allow the following use case scenarios by way of example for both Class A and B handsets:
1. Consider two subscribers A and B in a voice call. The AVS corresponding to this call for gA's UE may have an Incoming Leg (circuit switched) for ‘A.’ The AVS for B's UE has an incoming leg (“packet switched”) for ‘B.’ Thus, ‘A’ would be engaged in a circuit switched call and ‘B’ would be engaged in a packet switched call, i.e., the two parties in the call may use different access technologies. This example extends to multiparty calls.
2. Consider two subscribers A and B in a voice call. Both users are assumed to be using packet switched sessions (i.e., packet-switched [PS] modulation over the cellular spectrum). Under roaming conditions, at some point in this call, assume that both roam into new access networks that offer the resources (e.g., bandwidth) to support a video telephony sessions between A and B. These new access networks will correspond to new Incoming Legs added to the AVSs, along with new media renderers, and the policy in ME will dictate the use of the new access networks to support the video call. The new media renderers for the video telephony will be OCLs for each of the AVSs—i.e., AVS for A and an AVS for B.
3. Consider two subscribers A and B in a voice call. Assume that ‘A’ is in a circuit switched session and that ‘B’ is in a packet switched session. Now assume that ‘A’ roams into a new access network, e.g., WiFi, that supports video telephony. This new access network corresponds to a new Incoming Leg of the underlying AVS for A. The AVS under policy control may now be, as in use case number 2 above, converted into a video telephony session. An OCL may be added to correspond to a new OCL for the MR for the delivery of video telephony.
4. Consider two subscribers A and B in a circuit switched voice call. ‘A’ now wishes to send a multimedia message, e.g., photography, to ‘B.’ Assume that both ‘A’ and ‘B’ had previously roamed into new access networks that correspond to packet switched sessions (Incoming Legs) in the underlying AVS for each. These packet switched sessions can be used to deliver the multimedia object from A to B.

As will be clear to practitioners of the art, from the use cases 1-4, that by having access to multiple access networks under mobility situations, preferred embodiments of the present invention allow services that use a combination of packet and circuit switched access network technologies.

As explained above, preferred embodiments of the invention provide mechanisms to utilize non-IMS, legacy services within an IMS context. To do this, preferred embodiments of the invention logically separate the control and bearer parts of the legacy service. The control component of the service is handled by IMS, and the bearer component may remain independent of IMS. The control point (CP) 1016, referred to earlier, is the mechanism used to allow “out of band” media transport under control of IMS. Under preferred embodiments every AVS 1004 has an associated CP 1016, for example, logically within the AVS. More specifically, each AVS is designated to have an “Outgoing Leg” (OCL) 1010 that contains a CP. The CP has capability to transact with an Application Server (AS) using a standard protocol, e.g., using RTSP, and it has the capability to transact with programs in the UE called Media Renders (MRs), again using standard protocols, e.g., using SIP, or SOAP/HTTP. It is important to note that the CP itself may be considered an Application Server (AS) by the S-CSCF (i.e., interacted with as if it were an AS).

Now consider a UE requesting Mobile TV service. This request emanates from the UE (on an ICL) and is forwarded by the S-CSCF to the CP 1016 acting as an AS (in standard IMS fashion). Since the CP acting as an AS has access to IMS charging and authentication mechanisms, the first objective of re-using IMS infrastructure for legacy services is fulfilled. Once the charging and various other bookkeeping functions have been finished, the CP contacts the MobileTV server (e.g., illustrated as Content Server 1018 in FIG. 10) using RTSP protocol. Alternatively, the CP could pass control to another Application Server that now contacts the MobileTV server using RTSP”, i.e., there is a chain of Application Servers as in standard IMS. (chaining of application servers is a known technique). The CP instructs the MobileTV server to initiate media to the UE (at a designed IP address) and instructs the MR in the UE to render the incoming media. (See also FIG. 11.) This media transfer from the MS to the MR may use an out-of-band (non IMS) transport such as RTPIUDP/IP. Moreover, in some situations, other approaches to deliver media will be needed. For example, the MobileTV server may not support the capability of receiving a service request from client A and initiating service to a client at a different address. In this case the MobileTV server will be asked to send the media to the CP's address and it will be forwarded (we call this re-NATting) to the UE by the CP.

As can be appreciated from this discussion there will be communication between the CP and the UE for setting up media rendering etc. which will use valuable spectrum. In order to reduce the use of such spectrum-consuming communications we could use several mechanisms such as follows:
The relationship between an MR and a media server could be fixed a priori and pre-provisioned. Thus the CP always picks a pre-designated MR for a particular media server.
We introduce a notion of a CP Proxy (CPP) that is resident in the UE. The CPP has local service logic that decides what MR to pick for a particular media server. In other words, the CP-MR negotiation could be transformed into CPP-MR negotiation (which is local to a UE and hence does not use spectrum). Moreover, the CPP policies and logic could be updated periodically from the network resident CP at opportune times.

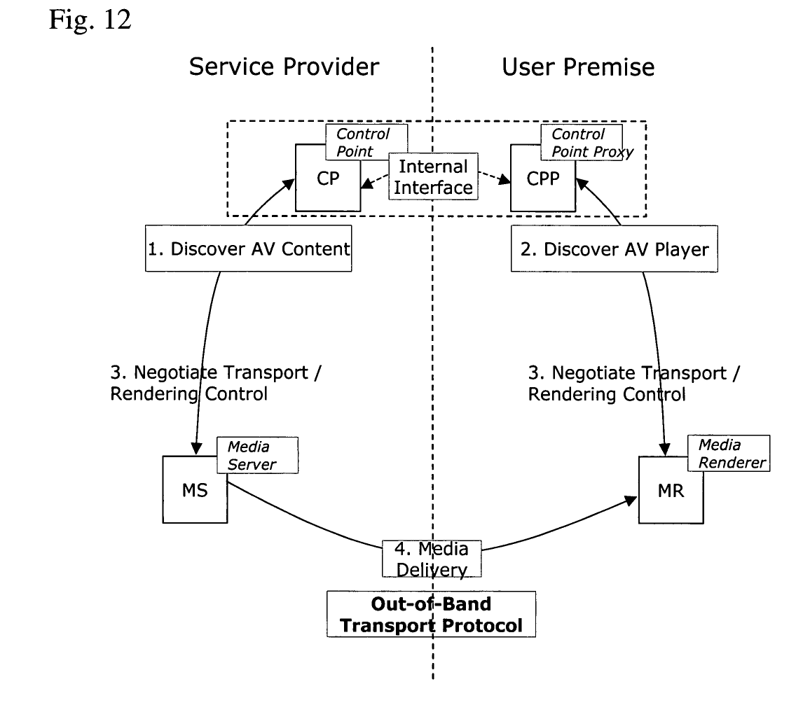

FIG. 12 illustrates the out-of-band media transport approach in which a CPP is used. As outlined above, in this situation, some of the activities performed by the CP are essentially delegated to CPP logic on the UE.

In yet another embodiment, the concept of MVNO-customized logic may be applied to so-called hybrid networks. In general a hybrid network is a combination of two or more individual networks. Examples of digital broadcast networks for joint use are DVB-H (Digital Video Broadcast-Handheld), and Media FLO (Forward Link Only). In a hybrid network, the broadcast network provides a high capacity but one-way transport for multimedia (video) traffic, while the UMTS (Universal Mobile Telecommunications System) network (or other network) may provide lower capacity two-way transport for interactive services. In such hybrid networks, the UMTS network is used for control and signaling purposes for the services offered by the broadcast component network. In this fashion, the UMTS network supplements the digital broadcast network by providing a control network or a network for user interactivity functions. Conversely, the broadcast network may supplement a UMTS (or other) network by providing certain broadcast functionality.

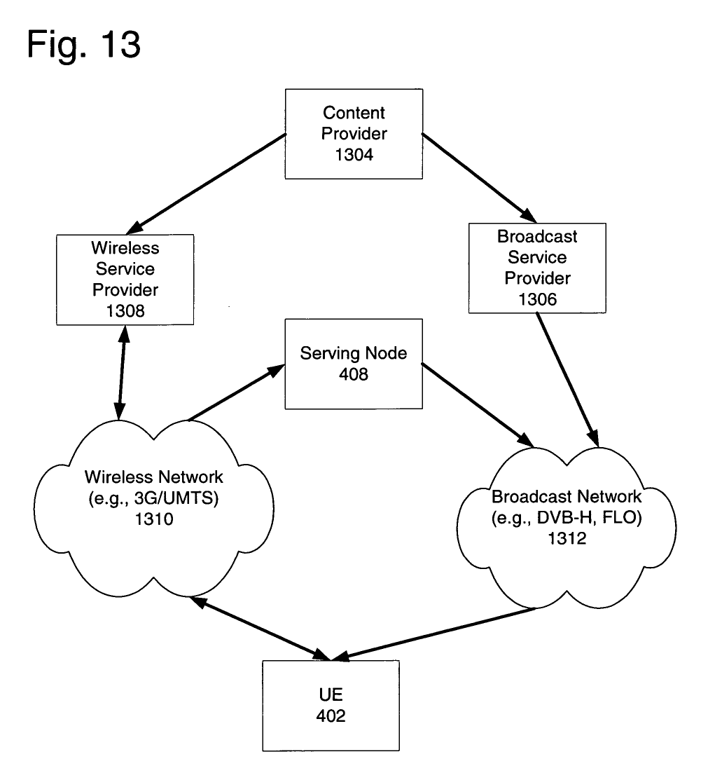

FIG. 13 is a flow diagram illustrating the use of customized MVNO logic with hybrid networks. Service to the handset UE 402 may be provided by a content provider 1304, broadcast provider 1306, or wireless provider 1308. Any of these three service providers may act as an MVNO by using one or more components of the hybrid network without owning that component. In such arrangements a mediation entity (e.g., the serving node 408 above) can allow interactions between the 3G/UMTS network component 1310 and the broadcast component 1312. The handset UE 402 sends service requests using the 3G (IMS) network 1310, which are conveyed to a control element, which could be the serving node 408. The control element 408 may computationally decide which component network to use to deliver the service based on a computation of a cost function, for example, within the policy logic as described above. The result of the cost function computation decides whether to use the broadcast or the 3G/UMTS network to deliver the service. The control element then directs the corresponding network elements in the chosen transport network to carry the service.

As explained above, the AVS model in the ME function can be used to support broadcast services as well. Consider by way of example a handset that has a DVB-H client, i.e., client logic that can receive and render broadcast content in a DVB-H network. When the handset client detects the DVB-H network it initiates a registration request with the UMTS network control element (since the UMTS network is used for interactive services, in particular for uplink services). In the preferred embodiment of the present invention this registration request is folded into an IMS registration request by passing the DVB-H client registration request via the Personal Agent (PA) client in the handset to the serving node 408. The sequence of step followed by PA originated registration request has been explained above. The sequence of steps in the network server are modified as follows:
1. When the registration request reaches the serving node 408, the ME function is invoked.
2. The ME function initiates an AVS session (if one does not exist for the handset, or uses an existing AVS session).
3. A new Incoming Leg is added to the AVS session corresponding to the broadcast network (i.e., the interactive part of the broadcast service; recall that the downlink broadcast service is not designed to use the IMS network).
4. The MS entity for the current AVS session is designated to be the Broadcast Content Server 1206 (i.e., the outgoing Leg of the AVS session is connected to the Broadcast server in the DVB-H network).
5. The MR entity of the current AVS session is designated to be a DVB-H client in the handset.

Now consider, by way of example, that the DVB-H client in the handset, having been registered with the DVB-H network, requests broadcast service. This service request will use the Incoming Leg of an AVS session and will be routed, as described above for any other IMS request, to the AVS for that UE from whence it is directed to the MS entity of the AVS session. The MS encodes in the request in the control protocol of the DVB-H server and sends the request to it. Negotiation for service (such as port numbers, timing and synchronization, etc.) between the DVB-H server and DVB-H client is now mediated by the MS entity of the AVS; i.e., the Outgoing Leg of the AVS is used by the DVB-H server to send information to the DVB-H client who uses the Incoming Leg of the AVS to send and respond. Thus, the MS entity acts as a translating mediator between the DVB-H server and DVB-H client using the Incoming and Outgoing Legs of the AVS session.

Uplink or interactivity services (e.g., when supplementing a broadcast network) may be implemented as an AS that the serving node 408 invokes. Likewise, when supplementing a UMTS network, a broadcast network server may be implemented or invoked as if it were an AS. Moreover, MVNOs or VSOs may be associated with the various entities.

As explained above, preferred embodiments of the invention provide mechanisms to allow legacy and IMS networks to inter-work. That is how we make both IMS services and non-IMS services co-exist and be usable on a given UE.

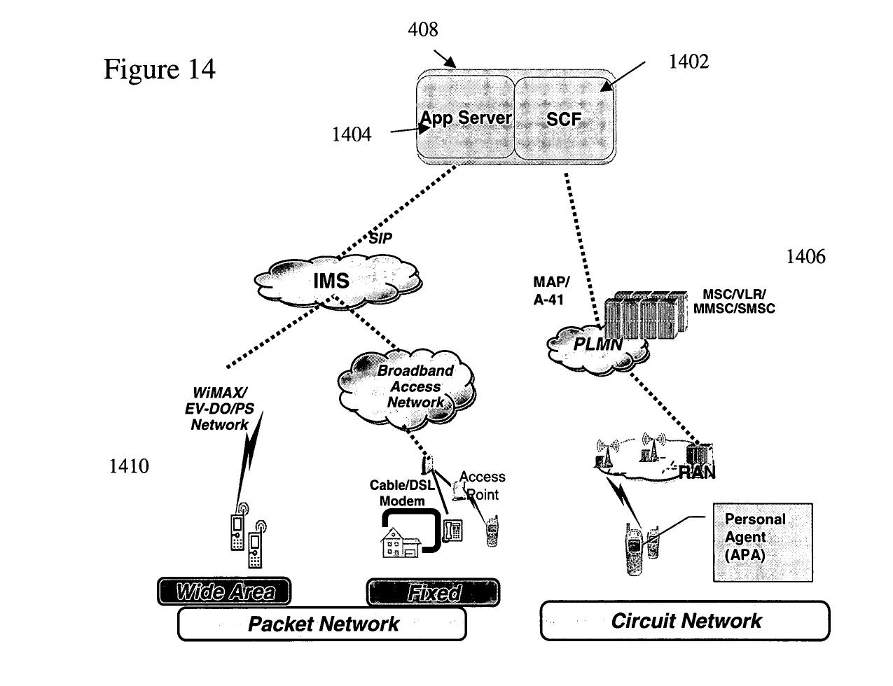

We now come to the question of inter-working legacy and IMS networks. Recall that the problem is that we need to be aware of circuit-switched (CS), packet-switched (PS) and WiFi services even though the handset itself may not support all three (or even two) simultaneously. With reference to FIG. 14, preferred embodiments of the invention utilize a Service Continuity Function (SCF) 1402 for this purpose (not to be confused with the Service Control Function in telecommunications networks). The SCF 1402 function is logic existing in the serving node 408 as an embedded AS, akin to several other embedded AS 1404 of preferred embodiments.

In conventional PSTN switches there is a logical function called the service control point (SCP). The SCP does services like toll calls, pre-paid calls etc. A PSTN switch can be programmed to receive call originating and call terminating triggers, even mid-call triggers, and pass them on to the SCP, which then handles them a la 3^{rd} party call control mechanisms. The protocols used to arm such triggers are called CAMEL, WIN, TCAP, etc.

The SCF 1402 of preferred embodiments operates akin to an SCP for a PSTN switch. Thus, if a circuit-switched phone originates a call, the MSC switch 1406 will be armed with the appropriate triggers to cause it to inform the SCF 1402 about this call origination (in a manner analogous to an MSC informing a SCP). The SCF will maintain state about this call. This state maintenance is done using AVS.

If now the handset enters a WiFi zone, e.g., 1410, a new ICL can be added to its AVS, just as the situation was described above in a purely IMS context. We will then have three ICLs for this handset: one ICL for the CS, one for PS, and one for the WiFi. (The last two are communicated to the AVS via registration done by the UE.) Think of this as having one eye in the CS world, another eye in the PS world, and yet a third eye in the WiFi world. If the handset now engages in a service using the PS session, and a voice call comes for the UE via the PSTN (which will appear as a trigger to the SCF), the SCF can respond to the trigger by generating a message to the UE using the available WiFi ICL, asking if the user wishes to receive the call. If a positive indication is received, the SCF can instruct the UE to “suspend” the PS session (e.g., MobileTV session) and to start the CS stack so the UE can handle the call. The SCF then responds to the voice call origination trigger that it had received from the MSC 1406, and the MSC then attempts to complete the voice call to the handset. Since the handset, in the meantime, has started the CS stack it is now in a position to receive and handle the call. Once the call is terminated, a call termination trigger is received by the SCF from the MSC and the SCF can ask the UE to “resume” the PS session (e.g., MobileTV service).

The MSC when it sends a trigger request to the SCP uses timers to await a response; typically, for TCAP the timers expire at 15 seconds; this represents an upper bound for the SCP to respond to the MSC. Likewise, the SCF will operate analogously.

Under one embodiment, when UE turns on as part of normal operations a MSC is accessed which in turn goes to the HLR for the network in conventional manner. The profile in the HLR for that UE specifies the various services for the UE. At least some of the services require the MSC to go to a SCF for authorization. Under these embodiments, the serving node 408 acts as the SCF to get such authorization. As part of that authorization process, the SCF will interact with the MSC to arm the appropriate triggers for that UE to provide inter-working.

A single serving node 408 may not be able to handle the load and volume of handsets. Thus, several serving nodes 408 may be grouped together with internal communication facilities to create a server farm of serving nodes, called a server node complex. Each MVNO is typically identified with a server node complex.

It will be further appreciated that the scope of the present invention is not limited to the above-described embodiments but rather is defined by the appended claims, and that these claims will encompass modifications and improvements to what has been described.

What is claimed:

1. A method of inter-working an IMS network having at least one serving node with a non-IMS network having at least one MSC so that network services may be provided to a user endpoint (UE) device, said services utilizing both the IMS network and the non-IMS network, comprising:
providing an application server in the IMS network;
posting an identification of at least one UE to the MSC;
posting corresponding triggers for the at least one identified UE to the MSC, said triggers identifying trigger events and identifying the application server as the entity to inform in response to the trigger event, said triggers being associated with corresponding service to the UE via the non-IMS network;
wherein, subsequent to the posting steps, a service is invoked to utilize the IMS network to provide service to the UE;
wherein, subsequent to the service being invoked to utilize the IMS network, the non-IMS network attempts to contact the UE and in the process activates one of said triggers and informed the application server; and
said application server responding to said triggers to contact said UE via the IMS network, in response to being informed of the trigger.

2. The method of claim 1 wherein the triggers are posted and armed when the UE registers in the network as part of authenticating the UE specification of services in the UE profile.
